(19) United States
(12) Patent Application Publication
(10) Pub. No.: US 2012/0013037 A1
(43) Pub. Date: Jan. 19, 2012

(54) Viscoelastic Extrusion Processing Method and Compositions for Biopolymers

(76) Inventors: Michael J. Riebel, Mankato, MN (US); Milton Riebel, Mankato, MN (US); Ryan W. Riebel, North Mankato, MN (US)

(21) Appl. No.: 13/183,256

(22) Filed: Jul. 14, 2011

Related U.S. Application Data
(60) Provisional application No. 61/364,341, filed on Jul. 14, 2010.

(51) Int. Cl. B29C 47/78

(52) U.S. Cl. 264/177.2

(57) ABSTRACT

A viscoelastic extrusion process (VEEP) for biopolymers such as polylactic acid is provided. The VEEP process removes many processing and performance limitations of PLA as well as creates performance sufficient to produce durable “nonbiodegradable” products as a direct replacement for PVC and other petrochemical profile and sheet extrusion applications. The VEEP process also retains a high degree of crystallinity within the PLA for increasing toughness and to lower its biodegradability. The invention also includes an integral process wherein rheology is highly modified to allow profile extrusion and higher melt strength wherein processing is lower than the melting point of the primary biopolymer and below the browning points of the natural fibers in the biopolymers viscoelastic state.

This application claims priority to U.S. Provisional Application No. 61/364,306, filed Jul. 14, 2010, the content of which is hereby incorporated in its entirety by reference.

Embodiments of the present invention relate to a method and products of making a biopolymeric material comprising a biopolymer and optional fillers or additives formed into a mixture, heating the mixture to its viscoelastic state, and profile or sheet extrusion method sufficient to maintain a crystalline nature of the biopolymeric material. The embodiment also relates to the making of various biopolymer profile and sheet compositions sufficient to mix, heat and form parts that can replace PVC products.

### BACKGROUND

Polymers with higher melt strength and indexes typically have lower viscosities and therefore do not have appropriate melt strength suitable for profile extrusion and provide difficulty in sheet extrusion processing. Polylactic acid typically has a melt index too high for high tolerance profile extrusion and provide difficulty in sheet extrusion when processed above its melt processing temperature of 390 degrees F. Polylactic acid in sheet extrusion for packaging is converted to a full amorphous plastic so that it is clear for biodegradable packaging applications. At this state the PLA is very brittle and has other undesired attributes.

With growing concerns over PVC in the market due to its hazardous nature, biobased solutions are seen as a good alternative being derived from a rapidly renewable resource and requiring less energy to produce than conventional petrochemical products. In addition biopolymers such as polylactic acid derived from corn, remove Co2 from the atmosphere reducing green house gases from the world.

This invention teaches a method and related products wherein polylactic acid is processed in its viscoelastic state to produce higher performance products, providing sufficient performance for durable goods, and allows for unique ability to load various additives, fillers and reinforcements. The environmental movement in the US and abroad continues to grow into a mainstream concern with growing demand for greener products and positions to remove hazardous materials from the workplace environment. PVC and formaldehyde based laminate worksurfaces and components are now being removed from many applications due to its toxic nature. Many organizations such as LEED, US Green Building Council, and Greenpeace are taking aggressive action to remove PVC and formaldehyde based products from the interior workplace. Large companies such as Walmart, Nike, Aveda, Herman Millar and many others have publically stated that their intent is to remove PVC from their product lines.

The demand continues to grow for green products to replace petrochemical plastics and hazardous polymer. This demand is driven by environmental awareness and by the architectural and green building communities based on making interior environments healthier. Materials commonly used in many architectural, institutional, and commercial applications for vertical and horizontal surfacing products are primarily derived from PVC and melamine formaldehyde laminates. With growing concerns over the usage of hazardous PVC and formaldehyde in interior applications, there is a need for environmentally friendly alternatives that meet both performance and economic requirements.

PVC has been classified by many groups as the “poison plastic” with environmental and hazardous issues though its life cycle. Over 7 billion pounds of PVC is discarded every year. The production of PVC requires the manufacturing of raw chemicals, including highly polluting chlorine, and cancer causing vinyl chloride monomer. Communities surrounding PVC chemical facilities suffer from serious toxic chemical pollution of their ground water supply, surface water and air. PVC also requires a large amount of toxic additives resulting in elevated human exposure to phthalates, lead, cadmium tin and other toxic chemicals. PVC in interior applications release these toxic substances as VOC's in buildings. Your surrounded and exposed to PVC products in your office every day. Deadly dioxins and hydrochloric acids are release when PVC burns or is incinerated. Organizations such as the Center for Health, Environmental and Justice has created many publications and a “PVC Free” agenda calling for banning of PVC burning and the complete phase out of PVC within ten years.

Biobased material are seen in the architectural, institutional, commercial and even residential markets as the best and “greenest” solution, but few products have entered the market and none as a direct replacement for PVC thermofoils used in surfacing and formaldehyde based high or low pressure laminates.

Biobased materials have been seen as the ultimate as a replacement for hazardous products in many architectural, commercial and residential applications. In addition these biorenewable materials are preferred over petrochemically derived plastic products. Bioplastics have been commonly used for various packaging film applications. Primarily PLA (polylactic acid) has been the most commercially successful of these bioplastics. PLA is a hard brittle plastic that is highly mobile or quickly turns into a liquid under open flame conditions. In addition PLA can not be easily extruded into profile shapes due to its high melt index and unique rheology. Most all of current PLA products and art are based on creating biodegradability. In our invention it is preferred that the products are not biodegradable, but biorenewable for long term commercial and durable goods applications

Biobased materials have been highly desired for green applications and to replace problematic petrochemically derived materials. Other biocomposite technology has been developed derived from a water based soybean resin and waste paper. This technology is limited to thicker parts due to compression molding processes typically available in thicknesses over 0.250″ and typically 3/4″ and over. This patent also covers the profile extrusion of biobased materials. These systems are highly hydrophilic in nature and require finishing with a clear wood finish. Even with using environmentally friendly finishing, this step costs more and creates difficulty in commercial field installations were fabrication is happening indoors and needs to be done quickly. The viscoelastic properties of biocomposite particles were first addressed in this application, but based on water solution protein resins.

The first development of viscoelastic processing of plastics was from a science fair project by Ryan Riebel in 2001, whom is one of the inventors of this application. This project was based on recycling of disposed compact disks that was thermally fused into a sheet to create very unique geometries and aesthetics. In this form individual particles were sprayed with different colorants and during the fusion process the individual particles remained in the composite, but the composite was fully fused into a singular solid by means of compression molding in a heated press at temperatures well below the melting point of the polycarbonate. This information related to the viscoelastic process was not disclosed and Ryan won 2^{nd} place at the Intel International Science Fair.

Most of the art found in regards to bioplastics has been based on biodegradable packaging. Many patents exist in regards to the addition of starch to PLA to produce a biodegradable films, coating, or packaging material including various additives and fillers. U.S. Pat. No. 7,297,394 Khemani; Kishan claims an article of manufacturing for use as a food wrap comprising of a biodegradable film derived from a biodegradable biopolymer and a small filler particle.

Prior art also teaches that virtually all biopolymers and plastics are processed in sheet or profile extrusion process at or above the polymers melting point. NatureWorks, the primary producers of PLA in the US, states that PLA needs to be processed at temperatures above its melting point typically from 360 F to over 400 F and its melt processing temperature typically is from 380 F to 420 F. In addition this art teaches that PLA needs to be melt/processed to a full amorphous state and remain clear which is over 380 F. PLA has been positioned for biodegradable packaging which requires clarity and maximum biodegradability which is achieved in PLA amorphous state when processing under normal conditions above its melting temperature.

Other art teaches that various plastic blends including polylactic acid bioplastics can be mixed with synthetic plastics to form flooring surfaces. U.S. Pat. No. 6,869,985 Mohanty claims a process of preparing a polylactic acid material with a expoxified oil wherein the PLA comprises about 30% and about 50% weight of a synthetic polymer consisting of polyvinyl chloride, polyolefins and other plastics or modified plastics to produce a thicker flooring tile. The inclusion of PVC and other synthetic plastics do not provide a true environmentally safe solution. In addition the mixing of PLA with synthetic plastics require that the admixture is processed above the melting points of the polymers.

Research has been undertaken in some areas of plastics engineering to use biodegradable materials. For example, U.S. Pat. No. 5,883,199 by McCarthy Ct al., the contents of which are hereby incorporated by reference in their entirety, discloses plastics including aliphatic polyesters that can be blended with PLA (polylactic acid or polylactide) to plasticize the PLA so it can be recycled and used again in packaging. Purportedly, the blends can be used to make biodegradable plastic film, sheets, and other products by conventional processing methods such as blown film, extrusion, and injection molding methods. The resulting blends can be used to manufacture bags, food packaging, laminated papers, food trays, fishing line, net, rope, diapers, disposable medical supplies, sanitary napkins, shampoo, drug, cosmetic, and beverage bottles, cutlery, brushes, combs, molded and extruded foamed articles such as packing material and cups, and cushions for flexible packing. These blends purportedly provide not only the excellent processibility of polyethylene, but also posses properties such as those of polyethylene terephthalate. In addition, these blends can purportedly be processed into films that are heat-sealable, unlike polyethylene terephthalate.

The art of polylactic acid processing and in the manufactures publications all state that PLA is processed from a crystalline state to an amorphous state producing a clear packaging or fiber material that is biodegradable or biocompositable. The amorphous state is required due to the fact that the vast majority of PLA is used for clear packaging and this market finds biodegradability highly desirable. The negative part of amorphous PLA is that it is highly brittle with a low heat distortion temperature and very poor melt processing strength.

Although these green biodegradable packing materials are moving our global community into better environment practices, their does exist a strong market demand for non-biodegradable biorenewable materials for more permanent applications or durable goods to replace hazardous or petrochemically derived products.

There is a large need to replace PVC profiles in many interior applications such as edgebanding, railings, corner guards, baseboard moldings, millwork, and other profile extrusion components. The usage of other petrochemical plastics to replace PVC has solved a small part of this problem, but still does not provide a biorenewable solution and does not fully address the “carbon footprint” of petrochemcial plastics. BioBased polymers derived from corn that removes Cot from the atmosphere in addition to lower energy requirements to product a biobased extrusion profile to replace PVC is clearly provides a more preferred and optimal replacement for such PVC products.

### SUMMARY

A viscoelastic extrusion process (VEEP) for biopolymers such as polylactic acid is provided. The VEEP process removes many processing and performance limitations of PLA as well as creates performance sufficient to produce durable “nonbiodegradable” products as a direct replacement for PVC and other petrochemical profile and sheet extrusion applications. The VEEP process also retains a high degree of crystallinity within the PLA for increasing toughness and to lower its biodegradability. The invention also includes an integral process wherein rheology is highly modified to allow profile extrusion and higher melt strength wherein processing is lower than the melting point of the primary biopolymer and below the browning points of the natural fibers in the biopolymers viscoelastic state.

A biopolymer industrial profile extrusion comprising of a bioplastic, bio-copolymer and biocomposite system in the form of a decorative extrusion profile based on a 3D continuous shape are further provided. This invention uses a process that maintains or increases the crystallinity of PLA, thereby producing a tougher part that is less biodegradable, or in some cases non-biodegradable, and also exhibits reduced stickiness with improved hot melt processing strength sufficient to make many profile extrusion components that can replace PVC as an environmentally friendly alternative. The resultant products represent and environmentally friendly replacement particularly to interior PVC profile extrusion applications. The product can be produced as a 100% or high percentage of renewable biosolution for commercial, institutional, architecturally specified and residential applications.

### DETAILED DESCRIPTION

The present invention relates to a viscoelastic extrusion process (VEEP) for biopolymers such as polylactic acid that removes many processing and performance limitations of PLA in addition creating performance sufficient to produce durable “nonbiodegradable” products as a direct replacement for PVC and other petrochemical profile and sheet extrusion applications. The VEEP process also retains a high degree of crystallinity within the PLA for increasing toughness and to lower its biodegradability. The invention also includes an integral process wherein rheology is highly modified to allow profile extrusion and higher melt strength wherein processing is lower than the melting point of the primary biopolymer and below the browning points of the natural fibers in the biopolymers viscoelastic state. This application incorporates by reference in its entirety U.S. patent application Ser. No. 13/182,910 filed Jul. 14, 2011, entitled “Biolaminate Composite Assembly and Related Methods”.

The present invention relates to a biopolymer industrial profile extrusion comprising of a bioplastic, bio-copolymer and biocomposite system in the form of a decorative extrusion profile based on a 3D continuous shape. This invention uses a process that maintains or increases the crystallinity, thereby producing a tougher part that is less biodegradable or not biodegradable as well as exhibits reduced stickiness and improved hot melt processing strength sufficient to make many profile extrusion components that can replace PVC as an environmentally friendly alternative. The resultant products represent and environmentally friendly replacement particularly to interior PVC profile extrusion applications. The product can be produced as a 100% or high percentage of renewable biosolution for commercial, institutional, architecturally specified and residential applications.

The present invention relates to specific polylactic acid and biobased additive compositions that can be processed using the VEEP process to produce material ranging from flexible to very rigid structural durable goods with the ability to replace flexible or rigid PVC products.

The invention also discloses the ability to produce these profiles primarily from PLA or PHA in the form of biopolymers, biocopolymers, modified biopolymers and biocomposites using a “viscoelastic extrusion process” (VEP) that allows the appropriate melt strength required to produce a high tolerance profile and maintain a high degree of crystallinity in the final materials as compared to the standard amorphous state of PLA after processing.

The invention discloses the use of various additive and bioadditives for functional values such as plasticizers, lubricants, fire retardants, fillers, fibers, colorants, polymer and plastic additives, various bioadditives and other common additives to modify the performance of the final product wherein the VEEP process enhances the ability to load these materials into PLA and provide improved performance.

Polylactic Acid

Polylactic acid is a highly engineered bioplastic. In comparing PLA to PVC, PLA has a significantly higher stiffness (modulus of elasticity) compared to PVC yielding improved wear resistance and hardness. By reducing the stiffness by means of a plasticizer equal to that of PVC, we see very similar overall performance to PVC and improved performance in certain performance categories for indoor durable good component requirements. This invention discloses a method for making PLA into a viable replacement for PVC.

PLA is a thermoplastic polyester derived from field corn of 2-hydroxy lactate (lactic acid) or lactide. The formula of the subunit is: —[O—CH(CH3)—CO]— The alpha-carbon of the monomer is optically active (L-configuration). The polylactic acid-based polymer is typically selected from the group consisting of D-polylactic acid, L-polylactic acid, D,L-polylactic acid, meso-polylactic acid, and any combination of D-polylactic acid, L-polylactic acid, D,L-polylactic acid and meso-polylactic acid. In one embodiment, the polylactic acid-based material includes predominantly PLLA (poly-L-Lactic acid). In one embodiment, the number average molecular weight is about 140,000, although a workable range for the polymer is between about 15,000 and about 300,000. In one embodiment, the PLA is L9000.TM.(Biomer, Germany), apolylactic acid)

Other forms of biopolymers included within this invention and derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

Bioplastics have become of increasing interest in recent years with their primary use being seen in biodegradable packaging and disposable bottles. Due to limitations in bioplastics such as PLA (polylactic acid) such as poor visocities and lack of melt strength when the plastic is molten creates extreme difficulties in creating profile extrusions and is virtually impossible to hold its shape for processing. PLA acts similar to honey when melted with a low viscosity as compared to extrusion grades of plastics. PLA will not holds its shape and only pour out of a mold. In sheet extrusion of PLA the molten liquid PLA flows from a die directly onto a cold roller not requiring holding a shape for this process. IN bottle applications, PLA is blow molded into a cold mold and again does not required to hold a shape in its molten condition.

A second major limitation of PLA is that it is limited to filler or additive addition. While processing PLA at or above its melting point a series of limitations are seen in the addition of various additives, fillers or reinforcements. Minerals such as icalcium carbonate, and forms of oxides creates issues with the chemistry of the PLA making it difficult or impossible to process at high loadings. The addition of liquids also has limitations when compounding PLA above its melting point creating issues with the chemistry and potentially lowering the molecular weight. In many cases the addition of most additives or fillers make PLA even more brittle than its natural brittle amorphous state.

Effect of moisture is also a big limitation for PLA. In Natureworks publications and in many other publications on PLA moisture is a series processing issue for PLA. In order to process moisture contents below 200 parts per million is the limit without series molecular degradation and processing problems.

PLA Processing

It is generally held that PLA has not been profile extruded because of these limitations. It is critical in extrusion processes to have plastics with an appropriate melt flow index that is related to its viscosity at a specific processing temperatures. Typically plastic with a lower MFI is preferred and critical to produce a high tolerance profile shape and maintain this shape through processing. Melt Flow Index's (MFI) below 2 and typically between a fractional to a 1 MFI are used for profile extrusion processing. PLA is a known biopolymer with a unique rheology and viscosity than other synthetic plastics. The lowest melt index PLA has been produced has been published between 4-8 MFI. At this flow rate the molten PLA acts more like honey with a similar viscosity as compared to the required profile extrusion viscosity more like “play dough”. In addition at the melting point and above where PLA is processed, the PLA is highly polar and is in virtually a 100% amorphous state. Most of all at this state within the specified processing temperature and above its melting point the material is very sticky and creates further problems in trying to profile extrude this material.

The melting temperatures of bioplastics such as PLA provides for other challenges. The processing point of PLA is around 370 degrees F. and typical melt processing temperatures are above this recommended between 380-420 F. At this temperature many natural fibers and materials will brown and even burn based on retention time in the process. This decolorization is problematic in making consistent decorative materials and can create a negative smell in the process and product. By the usage of a vegetable wax and/or biobased plasticizers the process within this invention allows for processing the PLA in its viscoelastic state at temperatures significantly below that of its melting point where these natural materials can be processed consistently.

It is common in plastic processing to extrude in the range of the melt/process temperature which is typically 20-40 degrees F. above the plastics melting point.

In virtually all art known for PLA, the PLA is processed into its clear amorphous state when processed at normal melting temperatures and processing temperatures used in melt extrusion. This creates a clear material good for packaging, but very brittle and with several processing and performance limitations. The VEP (viscoelastic extrusion process) processes PLA in a “rubbery” state well below the melting point of the PLA and maintaining a high degree of crystallinity in the final product. This improves both processing of the PLA improving its melt strength and greatly improving the end performance of the end material.

The VEEP Process

Part of this invention discloses a method of processing PLA or similar bioplastics and biocopolymers derived from PLA and PHA that are processed well below its melting point processing in its crystalline viscoelastic state. Additives and bioadditives are also disclosed that modify performance and assist in processing the bioplastics in this viscoselastic range to allow for similar performance and being competitive with faster production rates allowing the invention to be a direct replacement for many PVC extrusion applications.

This invention discloses that by means of viscoelastic extrusion processing, many of the current limitations of processing PLA and the end performance issues of PLA are resolved to a sufficient degree to produce a wide range of durable good and products.

The invention finds that PLA can be compatibilized through VEEP processing with a forms of biobased biolubricants and biobased bioplasticizers that will plasticizes and fully lubricate the PLA to form a unique bio-co-polymer while maintaining low shear and a high degree of crystallinity. The loading of the congegated soybean wax also provides a unique system wherein the SW melts at a very low temperature and at the viscoelastic point of the PLA. With the addition of minerals, fibers, natural fibers, cellulose, synthetics and other materials that can absorb and be impregnated, the SW fully penetrates most of these materials and provides a good interface with the pla/SW compound.

PLA also has not been extruded into high tolerance profiles due to its poor melt strength and high melt flow index. Embodiments of the present invention relate to a method of making a biopolymeric material comprising contacting a biopolymer sufficient to form a mixture, heating the mixture and profile extruding the mixture sufficient to create a biopolymeric material. Embodiments also relate to a method of making a biopolymeric material comprising contacting a biopolymer and a reactive composite sufficient to form a mixture, heating the mixture and profile extruding the mixture sufficient to create a biopolymeric material wherein the biopolymer is processed well below its melting point and with various additives and bioadditives to assist in higher speed processing and improvements to physical performance of the biolaminate

Definition of VEEP Process

Viscoelasticity is the property of materials that exhibit both viscous and elastic characteristics when undergoing deformation. Viscous materials resist shear flow and strain linearly with time when a stress is applied. Elastic materials strain instantaneously when stretched and just as quickly return to their original state once stress is removed. Visocelastic state have elements of both of these properties and, as such, exhibit time dependant strain. In melt processing PLA, the molten polylactic acid flows similar to warm honey with very low melt strength and no elastic property in this state. The VEEP process in this invention processes PLA above its heat deflection temperature and significantly lower than its melt temperature wherein the material exhibits an elastic state. This has also been proven in our experiments wherein PLA processed using the VEEP process is elastic when pulled in this state. PLA also will convert to an amorphous state around 370 F to 380 F degrees when processing which produces a clear material with no viscoelasticity. The VEEP process processes the PLA between 280 to 370 F and more preferably 300-340 F wherein the PLA remains cloudy showing its maintaining its crystalline state and clearly having a elastic state while maintaining a higher degree of melt strength.

The resultant PLA in this process also shows that the stickiness of the biopolymer is reduced. In processing PLA normally above its melting temperature, the PLA is very sticky with very poor melt strength. This has been documented in publications wherein sticking to downstream rollers in sheet extrusion and sticking in various extrusion tooling has been noted. The VEEP process greatly reduces or removes this stickiness factor primarily because the material is not converting to its amorphous “highly polar” state.

It is also well known that PLA is highly susceptible to moisture. Even very small percentages of moisture (over 200 parts per million) is sufficient to change the molecular weight or degrade the polylactic acid during convention melt extrusion processing. The VEEP process greatly reduces this wherein moisture has little to no effect on the polymer. In experiments, moisture was actually added well above this point and processed showing no effect on the final polymer or process.

The VEEP process is also defined as a temperature range for processing PLA between is heat deflection temperature of 130 F to below its melt processing point of 390 F. The VEEP process also is preferred using lower shear processing that can be accomplished by optimizing mechanical processing conditions and/or by means of lubricants including biolubricants as to best maintain the highest degree of crystallinity and toughness in the final extruded part.

VEEP processing of PLA can be accomplished in extrusion processing for both profile and sheet extrusion.

Characteristics of a Matching Profile using VEEP

A bioprofile is a continuous three dimensional shape produced by profile extrusion methods. A profile is designed to have high tolerance in all three dimensions of a continuous component as compared to a sheet product that required high degrees of tolerance in one dimension based on thickness control. In these cases support profiles are required for edgebanding on worksurfaces, corner guards, rails, millwork, window components, and baseboards for wall protection solutions, and other profiles to support, hold and compliment the biolaminate. A bioplastic, biocopolymer, or biocomposite profile is defined as follows:

Requirement to hold a specific tolerance from the shaped extrusion opening—In order to produce a quality profile extrusion the molten plastic requires the ability to hold its shape after exiting the die in free air until it is pulled into the cooling die and downstream equipment. During this time the material needs to hold its shape and be in the consistency of “play dough” PLA is more like honey in its molten state due to its inherently low viscosity and will not hold its shape. Molten plastic needs to have sufficient “melt strength” to hold its shape after exiting the three dimensional shaped die and maintain this shape until cooled to its hard solid form. In addition melt strength is required due to the fact that the hot profile is pulled into various downstream cooling tooling and through the long downstream cooling systems.

Required melt index and viscosity—Viscosity of plastics in processing is measured by melt index which is the amount of material flowing under a specific pressure and at a specific temperature as a function of a time period. Typically plastics for profile extrusion have a melt flow index MFI of 2 to a fraction melt. PLA at its melting point and processing temperature has a MFI of 4-8 which allows more flow and is in a more liquid state that does not allow for profile extrusion and ability to hold its shape.

Non stick issue—PLA is a highly polar plastic with a very high degree of stickiness. PLA has been used for various adhesive applications due to its high flow nature and high degree of adhesion. This is problematic in profile extrusion wherein PLA sticks to the sides of the profile die opening and does not provide a smooth surface or solid shape when processed at or above its melting point. This invention processes the PLA in its elastic amorphous state wherein the material is not sticky and has very unique rheology.

Pull strength and melt strength—in profile extrusion process, it is essential to have a good pull strength of the molten plastic as the material exits the profile extrusion die. The material needs to have a pull strength enough so that the material can be pulled without too much stretch or distortion of shape as it enters into the cooling calibrator. PLA virtually has no pull strength in at its melting point or above. Pull strength is critical in the production of both a shaped profile and in producing a high quality sheet as it needs to hold its shape the distance from the die exit to the downstream cooling systems without distortion, sagging, or change in shape.

Wall thickness—Typically profile extrusion components have wall thickness between 0.02″ to over 1″ and more typically wall thicknesses ranging from 0.05 to 0.25 depending on the final product needs. In many cases the profile part will have multiple walls or contours that may have various thicknesses within the extrusion profile. It is critical to maintain appropriate melt strength, optimal part integrity, minimal part distortion and other factors to create a quality profile extrusion part.

Part geometry definitions and distortion/sag—Profile extrusion are defined as a three-dimensional continuous shape consisting of more than one side, wall shape or contour. It maybe in the form of a solid, hollow, or multiple hollow continuous shape. As growing up as children we all are familiar with Play Dough and the toy that extruded the play dough into shapes. Play dough is of the appropriate viscosity and visco elasticity to maintain a shape in an unsupported process. PLA in its molten state above its melting temperature would be similar to replacing the play dough with the honey. Honey would have not ability to hold a shape and be very sticky just pouring out of the shape without any pressure.

Rigid, semi rigid & flexible applications—Profiles are typically produced in a rigid, semi-rigid, and flexible profiles of which many use forms of PVC for rigid and semi rigid and PVC with higher percentages of plasticizers for flexible. In all three types of PVC's they typically have the same low melt index that allows for profile extrusion processing.

Profile Extrusion Process

In the typical extrusion of plastics, raw thermoplastic material in the form of small beads (often called resin in the industry) is gravity fed from a top mounted hopper into the barrel of the extruder. Additives such as colorants and UV inhibitors (in either liquid or pellet form) are often used and can be mixed into the resin prior to arriving at the hopper.

The material enters through the feed throat (an opening near the rear of the barrel) and comes into contact with the screw. The rotating screw (normally turning at up to 120 rpm) forces the plastic beads forward into the barrel which is heated to the desired melt temperature of the molten plastic (usually around 200° C./400° F.). In most processes, a heating profile is set for the barrel in which three or more independently controlled heaters gradually increase the temperature of the barrel from the rear (where the plastic enters) to the front. This allows the plastic beads to melt gradually as they are pushed through the barrel and lowers the risk of overheating which may cause degradation in the polymer. Extra heat is contributed by the intense pressure and friction taking place inside the barrel. In fact, if an extrusion line is running a certain material fast enough, the heaters can be shut off and the melt temperature maintained by pressure and friction alone inside the barrel. In most extruders, cooling fans are present to keep the temperature below a set value if too much heat is generated.

At the front of the barrel, the molten plastic leaves the screw and travels through a screen pack to remove any contaminants in the melt. The screens are reinforced by a breaker plate (a thick metal puck with many holes drilled through it) since the pressure at this point can exceed 5000 psi (34 MPa). The screen pack/breaker plate assembly also serves to create back pressure in the barrel. Back pressure is required for uniform melting and proper mixing of the polymer. This breaker plate also does the function of converting “rotational memory” of the molten plastic into “longitudinal memory”

After passing through the breaker plate, the molten plastic enters the die. The die is what gives the final product its profile and must be designed so that the molten plastic evenly flows from a cylindrical profile, to the product's profile shape. Uneven flow at this stage would produce a product with unwanted stresses at certain points in the profile. These stresses can cause warping upon cooling. Almost any shape imaginable can be created so long as it is a continuous profile.

The product must now be cooled and this is usually achieved by pulling the extrudate through a water bath. Plastics are very good thermal insulators and are therefore difficult to cool quickly. Compared with steel, plastic conducts its heat away 2000 times more slowly. In a tube or pipe extrusion line, a sealed water bath is acted upon by a carefully controlled vacuum to keep the newly formed and still molten tube or pipe from collapsing. For products such as plastic sheeting, the cooling is achieved by pulling through a set of cooling rolls.

Sometimes on the same line a secondary process may occur before the product has finished its run. In the manufacture of adhesive tape, a second extruder melts adhesive and applies this to the plastic sheet while it's still hot. Once the product has cooled, it can be spooled, or cut into lengths for later use.

PLA Limitations and Issues

The melting temperature of PLA as tested and confirmed in technical publications by Natureworks (division of Cargill producing PLA) states a temperature greater than 390 degrees F. Typical processing temperatures for sheet and bottles are above the melting point over 410 degrees F. This is also common for most all synthetic plastics where then need to be processed 20-50 degrees above the plastics melting point. At this recommended processing temperature the melt index of the material is very high stated and measured between 4-9 MFI. Typically higher viscosity or lower melt indexes are required for profile extrusion processing of plastics typically between 2MFI at the highest and more preferably less than 1 or “fractional melt”. In addition according to Natureworks, PLA is highly susceptible to moisture and too high of shear in its melted phase. Moisture of more than 250 parts per million can adversely effect the viscosity to make it even thinner and more brittle making its even more difficult to process. To accommodate this the PLA pellets required significant drying time prior to processing over 4 hours at over 170 degrees F. In addition too high of shear also can lower the viscosity of the material in its molten state creating additional processing problems. These and other processing problems and the misconception that bioplastics are only used for biodegradable applications creates a mind set that PLA is a substandard plastic and very limited in application.

This invention has developed a method to extrude PLA into shapes and compositions that assure that the material will not degrade in various longer term commercial profile extruded applications and products. Secondly, the inventions disclosure methods of processing that provides high quality profiles and material compositions that can directly compete with current hazardous plastics such as PVC in architectural, commercial and industrial markets.

The ability to use PLA in clear packaging films is known although similar limitations makes it difficult for processing. This invention uses various biolubricants/plasticizers and processing methods that only allow profile production but also allow for loadings of fire retardants to produce a FR class I sheet product that is an environmentally friendly alternative to PVC products. In building sheet products a class I fire rating is required for most building codes in the US and similar codes in the EC and Japan. In order to provide this and maintain an environmental position, a natural non-halogenated mineral and char promoter is required. The ability to use biolubrication not only allows for processing PLA below its melt point and provide for improved Melt index and viscosity but allows for loading of these materials without creating the normally high degree of brittleness.

Patent application 2445.001 US1 (Nelson/Riebel), herein incorporated by reference in its entirety, teaches that PLA in combination with an EVA type or synthetic form of binder allows PLA to be processed below its melting point. In addition this teaches that fire retardants can be added. In this technology the combination of the binder and highly polar PLA makes is difficult to load fire retardant to the required level to reach a class I rating without the material becoming extremely brittle and not meeting the requirements of PVC applications.

This invention uses various form of bioplasticizer/biolubrication system that replaces the binder in the above art. This allows more flexibility in mechanical properties even with loadings of fire retardants and non compatible fillers or additives.

PLA has very unique characteristics in rheology. PLA has a low HDT or heat distortion temperature in which the plastic will get soft and pliable at temperatures above 120 degrees F. Between the HDT point and the true melting point of the PLA at 390 degrees F., the material goes though different states and rheological changes. In addition the PLA is an amorphous resin, but is highly crystalline once fully melted and cooled to a specific process.

By processing at a specific temperature range wherein the PLA is in an “elastic state” similar to a rubber, PLA stays in its amorphous state and acts similar to that of various other elastomeric materials. Also in this state the material is less susceptible to moisture and shear. In fact in processing we found that higher shear levels when the PLA is in this elastomeric state provides advantages in profile extrusion and with the addition of various additives.

At this processing state, we were able to blend in various additives in liquid or solid forms in addition adding various other polymeric additives to develop a wider range of end performance for various non-biodegradable profile extrusion applications.

The melting temperature of PLA as tested and confirmed in technical publications by Natureworks (division of Cargill producing PLA) states a temperature greater than 390 degrees F. Typical processing temperatures for sheet and bottles are above the melting point over 410 degrees F. This is also common for most all synthetic plastics where then need to be processed 20-50 degrees above the plastics melting point. At this recommended processing temperature the melt index of the material is very high stated and measured between 4-9 MFI. Typically higher viscosity or lower melt indexes are required for profile extrusion processing of plastics typically between 2MFI at the highest and more preferably less than 1 or “fractional melt”. In addition according to Natureworks, PLA is highly susceptible to moisture and too high of shear in its melted phase. Moisture of more than 250 parts per million can adversely effect the viscosity to make it even thinner and more brittle making its even more difficult to process. To accommodate this the PLA pellets required significant drying time prior to processing over 4 hours at over 170 degrees F. In addition too high of shear also can lower the viscosity of the material in its molten state creating additional processing problems. These and other processing problems and the misconception that bioplastics are only used for biodegradable applications creates a mind set that PLA is a substandard plastic and very limited in application.

This invention has developed a method to extrude PLA into shapes and compositions that assure that the material will not degrade in various longer term commercial profile extruded applications and products. Secondly, the inventions disclosure methods of processing that provides high quality profiles and material compositions that can directly compete with current hazardous plastics such as PVC in architectural, commercial and industrial markets.

In addition while processing PLA in its elastomeric state we see different rheologies and lower melt indexes that allow higher melt strengths and ability to hold shape during profile extrusion processing. Using higher shear rates and temperature over 50 degrees BELOW the melting point creates a unique state in the PLA wherein its does not convert into a full crystalline form and acts more like an elastomer. Typically temperatures between 280 to 330 F and more preferably temperatures between 300 to 320 F in combination with higher shear allows the material to be processed even with higher moisture contents and various additives into a form of elastic material that can be profile extruded with sufficient melt strength, melt index, and shape retention to create a series of environmentally friendly profile extrusion components.

At this elastomeric and crystalline state the PLA is significantly less sticky. In addition various other additives can be added to further provide good ship in profile dies and less stickiness in down stream calibration during the cooling phase of profile extrusion.

Additives, Fillers and Reinforcements

In processing many additives, fillers and reinforcement, these additives can have some degree of retained moisture or other chemistries that negatively effect processing PLA in standard melt processing methods. By means of VEEP processing the sensitivity of the PLA is significantly reduced when the PLA is in this viscoelastic state. This better allows a wider range of additives, fibers, fillers and other materials to be compounded with PLA and also allows higher loadings of materials without adverse processing or final properties issues.

The invention also includes blends of fire retardants with various minerals such as mica and silica to improve flow dynamics and properties of the fire retardant. Such class is fire retardants are commonly used in dry fire extinguishers as and ABC grade. These are typically an ammonium phosphorous containing mica, silica and other fine minerals for good flow characteristics in dry fire extinguishers. Other environmentally friendly non halogenated fire retardants include magnesium hydroxide and alumina tyhydrates.

The invention also includes blends of biopolymer or polymer additives that can be processed using the VEEP process including, but not limited to; plasticizers, lubricants, impact modifiers, colorants, decorative particles and fibers, UV stabilizers, antimicrobials and other additives.

Additional additives can be added to the biopolymer profile including but not limited to: functional additives, fillers, reinforcements, polymer extenders, colorants, and other functional materials. Additives can include but are not limited to: UV inhibitors, impact modifiers, plasticizers, colorants, polymer extenders such as common plastics (i.e. polyethylene, polypropylene, EVA, EMA, TPE's, etc) Fillers and reinforcements can include, but not limited to: wood fiber, wood flour, wood strands, agricultural fiber, agricultural flour, papermill sludge, mineral fillers, fiberglass, carbon fibers, talc, calcium carbonate, and other such fillers and reinforcements. Additional additives may include but not limited to fire retardants and others

Polymer Morphology

Molecular shape and the way molecules are arranged in a solid are important factors in determining the properties of polymers. From polymers that crumble to the touch to those used in bullet proof vests, the molecular structure, conformation and orientation of the polymers can have a major effect on the macroscopic properties of the material. The general concept of self-assembly enters into the organization of molecules on the micro and macroscopic scale as they aggregate into more ordered structures. Crystallization, discussed below, is an example of the self-assembly process as is the orientational organization of liquid crystals to be discussed later.

We need to distinguish here, between crystalline and amorphous materials and then show how these forms coexist in polymers. Consider a comparison between glass, an amorphous material, and ice which is crystalline. Despite their common appearance as hard, clear material, capable of being melted, a difference is apparent when viewed between crossed polarizers, as illustrated below:

The highly ordered crystalline structure of ice changes the apparent properties of the polarized light, and the ice appears bright. Glass and water, lacking that highly ordered structure, both appear dark.

The amorphous morphology of glass leads to very different properties from crystalline solids. This is illustrated in the heating process where the application of heat to glass turns it from a brittle solid-like material at room temperature to a viscous liquid, liquid, as discussed later in more detail under Thermal Properties of Polymers. In contrast, the application of heat to ice turns it from solid to liquid. Crystalline melting leads to striking changes in optical properties during the melting process when observed through crossed polarizers. This is illustrated in the following movie of the melting of an organic crystalline material. Note that while the temperatures are not recorded, the entire process occurs over a very narrow temperature range.

The reasons for the differing behaviors lie mainly in the structure of the solids. Crystalline materials have their molecules arranged in repeating patterns. Table salt has one of the simplest atomic structures with its component atoms, Na+ and Cl−, arranged in alternating rows and the structure of a small cube. Salt, sugar, ice and most metals are crystalline materials. As such, they all tend to have highly ordered and regular structures. Amorphous materials, by contrast, have their molecules arranged randomly and in long chains which twist and curve around one-another, making large regions of highly structured morphology unlikely.

The morphology of most polymers is semi-crystalline. That is, they form mixtures of small crystals and amorphous material and melt over a range of temperature instead of at a single melting point. The crystalline material shows a high degree of order formed by folding and stacking of the polymer chains. The amorphous or glass-like structure shows no long range order, and the chains are tangled. There are some polymers that are completely amorphous, but most are a combination with the tangled and disordered regions surrounding the crystalline areas. Such a combination is shown in the following diagram.

An amorphous solid is formed when the chains have little orientation throughout the bulk polymer. The glass transition temperature is the point at which the polymer hardens into an amorphous solid. This term is used because the amorphous solid has properties similar to glass.

In the crystallization process, it has been observed that relatively short chains organize themselves into crystalline structures more readily than longer molecules. Therefore, the degree of polymerization (DP) is an important factor in determining the crystallinity of a polymer. Polymers with a high DP have difficulty organizing into layers because they tend to become tangled.

The cooling rate also influences the amount of crystallinity. Slow cooling provides time for greater amounts of crystallization to occur. Fast rates, on the other hand, such as rapid quenches, yield highly amorphous materials. For a more complete discussion, see the section on thermal properties. Subsequent annealing (heating and holding at an appropriate temperature below the crystalline melting point, followed by slow cooling) will produce a significant increase in crystallinity in most polymers, as well as relieving stresses.

Low molecular weight polymers (short chains) are generally weaker in strength. Although they are crystalline, only weak Van der Waals forces hold the lattice together. This allows the crystalline layers to slip past one another causing a break in the material. High DP (amorphous) polymers, however, have greater strength because the molecules become tangled between layers. For uses and examples of high and low DP polymers, see the section on Polymer Applications. In the case of fibers, stretching to 3 or more times their original length when in a semi-crystalline state produces increased chain alignment, crystallinity and strength.

In most polymers, the combination of crystalline and amorphous structures forms a material with advantageous properties of strength and stiffness.

Also influencing the polymer morphology is the size and shape of the monomers' substituent groups. If the monomers are large and irregular, it is difficult for the polymer chains to arrange themselves in an ordered manner, resulting in a more amorphous solid. Likewise, smaller monomers, and monomers that have a very regular structure (e.g. rod-like) will form more crystalline polymers.

Crystallization occurs when polymer chains fold up on themselves in a repeating, symmetrical pattern. Long polymer chains tend to become entangled on themselves, which prevents full crystallization in all but the most carefully controlled circumstances. PET is no exception to this rule; 60% crystallization is the upper limit for commercial products, with the exception of polyester fibers.

PET in its natural state is a crystalline resin. We are able to produce clear products by rapidly cooling molten polymer to form an amorphous solid. Like glass, amorphous PET forms when its molecules are not given enough time to arrange themselves in an orderly fashion as the melt is cooled. At room temperature the molecules are frozen in place, but if enough heat energy is put back into them, they begin to move again, allowing crystals to nucleate and grow.

Like most materials, PET tends to produce many small crystallites when crystallized from an amorphous solid, rather than forming one large single crystal. Light tends to scatter as it crosses the boundaries between crystallites and the amorphous regions between them. This scattering means that crystalline PET opaque and white in most cases. Fiber drawing is among the few industrial processes that produces a nearly single-crystal product

Viscous flow. Under very slow rates of loading some of the strain may be irrecoverable, indicating that the material has deformed in part like a viscous liquid rather than as a solid. viscous flow is the result of slow displacement of entire polymer chains in relation to their neighbors. Crosslinked or network polymers do not undergo viscous flow, which is prevented by the cross-links between chains.

The deformational response to stress of crystalline polymers is considerably more complex than that of amorphous polymers. Most crystalline polymers contain amorphous regions (CBD 154) that show viscoelastic behavior. Far below Tg molecular mobility of the crystalline polymer will be essentially absent and the material will behave as a hard elastic solid. Above the melting temperature (Tin) the polymer will no longer be crystalline and will behave as an amorphous viscoelastic liquid. Between Tg and Tm, and somewhat below Tg, which is usually the range of temperature at which these materials are used, the response to stress is complex.

According to Natureworks, the primary manufacture of PLA in the United States, the most common grade of PLA are semi-crystalline biopolymer with a relatively slow nucleation and crystallization rates. As a result, most extruded objects from these grades such as sheets and pellets will be 100% amorphous after processing and normal quenching operations. In addition, all PLA is subject to hydrolysis when heated in the presence of water. Therefore drying is required to prevent a loss in properties according to Natureworks. Uncrystallized and amorphous grades of PLA becomes sticky and clumps when its temperature reaches 140 degrees F. The crystallization temperature of PLA is published is recommended in a range from 190 to 210 degrees F. (88-99 C) wherein the material is crystallized appropriately.

At a normal level of crystallization, PLA pellets or materials will appear cloudy due to light polarization normally seen in highly crystalline materials as compared to very clear PLA and plastics which are highly amorphous. As in most plastics clear amorphous materials typically have a significantly higher degree of brittleness and stiffness as compared to most crystalline materials which naturally have a higher degree of impact strength and flexibility.

PLA is currently used for clear packaging sheet and clear bottles which requires that the PLA material is processed to its fully amorphous state from its nature crystalline state. In starting processing the crystalline pellets, the crystalline nature does not allow stickiness and clumping during drying. Drying of PLA is a critical step being the material is highly susceptible to hydrolysis from even the smallest amounts of moisture above its melting point. Thus processors of PLA dry the highly crystalline material then convert it to a clear amorphous material in sheet and bottle production.

The process defined within this invention uses a novel method and optional compositions to maintain crystallinity of the PLA through the process and maintaining this in the end profile extrusion or sheet components. The process within this invention uses higher shear, which is not recommended by the manufacture, and very low processing temperatures typically below that of 320 or 300 F to process the material in its elastomeric state well below its melting point and recommended processing point of 380 to 420 where the material converts to a fully amorphous material. This provides a cloudy extruded component vs a clear and more brittle packaging material.

Secondly, at this processing temperature we are above the temperatures required to fully crystallize the material but below the temperature and processing parameters to create a full amorphous material. The resultant materials are cloudy, but have a significantly higher flexibility while still maintaining a high degree of mechanical performance.

By maintaining a crystalline state or partial crystalline states by the process within this invention we greatly reduce stickiness of the polymer and maintain properties more advantageous for products that can replace PVC in profile and extrusion applications. Also within the processing parameters of this invention, the material has a different rheology and melt index that can allow processing into extruded three dimensional shapes. In addition by maintaining a highly crystalline state, the resultant products is tougher and less brittle as compared to neat PLA. Although a highly crystalline material is typically not clear, most of the PVC replacement applications within this invention are typically semitransparent or most likely an opaque color.

By processing in its viscoelastic state by maintaining low shear and very low processing temperatures we maintain the crystalline state in the material, lower biodegradability, remove stickiness of the polylactic acid during processing, improve toughness of the final part, and provide sufficient melt strength to allow the profile extrusion of high tolerance part that can replace PVC profile extrusion components as an environmentally friendly replace.

Additives can also assist in this invention and still maintain crystalline state of the PLA or PLA admixtures. Nanomaterials, fillers, fibers, proteins, and other materials can increase the nucleation of the PLA and effect the crystalline states to the material. By processing well below the melting point and through the usage of high shear we are able to maintain a less brittle state of the PLA and be able to closer match the desired properties of PVC products and applications requirements. Other nucleating agents, fillers, fibers and materials have been tested with positive results using this novel process methodology.

PLA is highly problematic if any moisture is on the surface or within the polymer during processing. This will create a breakdown in molecular weight and create other issues and problems. This is seen primarily as the PLA reaches its melting point and reacts with the moisture. This invention processes below the melting point and in its viscoelastic state. Thus we see significantly less susceptibility from moisture as compared to full amorphous melt processing. Thus in our experiments we found that material with moisture vs full dried material showed little difference in processing or final performance requirements.

Other materials can be added to further assist in widening the performance of the material while maintaining or assisting crystallinity within the PLA. Other forms of crystalline polymers such as PE, PP, EVA and others can be used as an additive to maintain crystallinity and modify end performance. Plasticizers also can be used to further lower the elastomeric state temperature and allow for processing well below 300 degrees F.

Other materials such as natural corn proteins used for microcellular nucleation also has an positive effect on the rheological properties of the material while maintaining performance by still further lowering processing temperatures.

### EXPERIMENTS

### Experiment 1

Regrind waste compact disc material was receive from GE Plastic. The waste CD's were industrial regrind from compact disc production with color labels and metalized back. The material was ground into a fractured particles with an rough average size of 0.25″. The CD particles were screened to a more uniform size. The particles were placed in a compression molding machine with a simple square heated mold with pressures of 500 psi. The experiment started at temperatures below 250 degrees F. and running to over 420 degrees F. in 50 degree increments. The experiment found that at temperatures above 380 F the particles melted together with no visible signs of individual particle bounders. At temperatures below 300 F, the particles did not fuse together, but were slightly deformed. At temperatures between 300 F to 350 F the particles softened and formed to a minimum energy state maintaining individual particle boundaries while still fusing the material into a solid strong piece that could be machined after cooling. After testing we found that this temperature was above the heat deflection point, but well below the melting point of polycarbonate. A second test group was ran wherein the individual particles were sprayed with different color paints. The process of heat compression fusion was redone also showing more defined boundary conditions and the point wherein the polycarbonate melted under pressure that this boundaries not maintained.

PLA from Natureworks was put into an twin screw extrusion system and ran through a series of temperatures at low RPM and low shear rates. Starting at the recommended melt processing temperature of 400 F the resultant material poured from the die like molten honey and did not hold any shape. The PLA was clear in appearance. The material also stuck to the downstream conveyor belt removing the extruded material. The temperatures were dropped until the extruded locked up. At temperatures between 300 F to 350 F we found that the PLA became cloudy and held the shape of the die. In pulling the extruded material it clear had an elastic property with significantly less stickiness of the extruded material.

PLA was then extruded with 1% Polysoy soybean wax from ADM at temperatures of 320 F. In comparing the neat PLA to the soybean wax/PLA composition we noticed that the energy inputs to the extruded were significantly lowered and the material held a better shape, was even more cloudy, and less stickiness. The resultant PLA extrusion was more flexible using the 1% soybean wax and was also not brittle in impact testing.

PLA Rods from the previous extrusion tests were used for testing wherein one rod was from melt/process temperatures above 400 degrees F, another rod from 320 F and a third rod at 320 F with the addition of soybean wax. The first rod was very brittle and shattered upon impact. The second rod had significantly better impact resistance. The third rod was more flexible in nature with very good impact resistance.

PLA pellets were taken and separated into two groups. The first group of pellets were previously dried using a standard plastic pellet drying system to remove all residual moisture. The second group of PLA pellets had water sprayed onto the surfaces and sat outside for a week. Both groups were processed at 390 F using the standard melt process. The dried PLA processed, but still had very poor melt strength and flowed like warm honey. The “wet” PLA was even more watery and the residual moisture created large “popping” from the output of the extruder from water vapor release under pressure. The processing temperature was dropped to 310 degrees F. and repeated. The dried PLA ran well with good elastomeric properties, sufficient melt strength to hold a shape and was now cloudy with good impact strength. The second wet group was also extruded. To our surprise their was no popping or rapid water vapor release. The melt strength and elastomeric properties were retained. About 1 foot downstream we could see very small bubbles in the material wherein the water vapor was trying to be released but would not reach the surface.

PLA was placed into a single screw extruded and the temperature was slowly dropped to below 300 F. Even though the machine was set below this level the material continued to flow and maintain a temperature of the PLA at 310 degrees F. due to the mechanical shear heat input. Under this higher shear condition the material was still not brittle and was in a crystalline cloudy state.

A cellulosic filler was prepared by grinding cellulose into fine fibrous particles. This was added to the PLA pellets at 5% total weight of the mixture. The material was first processed above 390 F of the common melt processing temperature. The residual moisture in the fiber and other incompatibilities created a very rough material output wherein the surface of the extruded part was bumpy and sticky not being able to hold a shape. We also noticed that the interface of the fiber to the PLA was not optimal with small microscopic air bubbles at these interfaces. The resultant material was extremely brittle like glass. The temperatures were lowered wherein the material was in its viscoelastic state at a temperature of 330 F. The material quickly smoothed out and looked more homogenous. The material held its shape well and could form a complex shape. The material had a better impact resistance and we seen better interfaces between the fiber and PLA.

Sheet Extrusion with Thermofoiling to amorphous state. PLA with a 2% addition of soybean wax was dried blended and placed into a single screw extrusion system with a 60 inch sheet die. Processing temperatures in the barrel ranged from 310 to 340 F and processed into a sheet. The melt temperature of the material was maintained below 340 F. The sheet were semitransparent as compared to the full melt/processed PLA that was both fully amorphous and clear. The sheets where then thermofoiled at a temperature of 180 F. This increased the clarity and we assume reducing the crystallinity of the material making it harder which is desirable for this application.

### Embodiments

A method of processing polylactic acid using a viscoelastic process method. Wherein the viscoelastic process requires processing PLA below its melt processing point and the PLA maintains a higher degree of crystallinity.

Cloudy vs clear

Preferably between 250 F to 360 F and more preferably between 300-340F.

Wherein the profile is designed to meet the needs as a replacement for PVC profiles

Wherein the process maintains a high degree of crystallinity

Wherein the process reduces the biodegradability of the material

Wherein the process allows for same moisture percentage without molecular breakdown

Wherein the process allows for various fillers

Wherein the process allows for various additives

A process that reduces the brittleness of PLA in contact with various fillers, additives and reinforcements.

Wherein the bioprofile is a high tolerance three dimensional shape produced by profile extrusion methods.

Wherein profile is produce at a processing temperature range between 280 to 350 F
More preferably between 300-3220 F

Wherein bioprofile includes a fiber or reinforcement

Wherein bioprofile includes additives

A method of viscoelastic processing of polylactic acid wherein a high tolerance crystalline profile extrusion component is produced.
Wherein profile component comprises a baseboard
Wherein profile component comprises a window profile
Wherein profile component comprises an edgebanding
Wherein profile component comprises a architectural millwork
Wherein profile component comprises architectural corner guard Wherein profile component comprise door components
Wherein profile component comprises pipe
Wherein profile component comprises a replacement for rigid PVC profiles.

What is claimed is:

1. A method of processing polylactic acid (PLA) using a viscoelastic process, comprising:
processing the PLA below its melt processing point to form a profile;
wherein the PLA maintains a high degree of crystallinity after processing.

2. The method of claim 1, wherein processing is done between 250° F. and 360° F.

3. The method of claim 2, wherein processing is done between 300° F. and 340° F.

4. The method of claim 1, wherein the PLA remains cloudy during processing.

5. The method of claim 1, wherein the profile is suitable for replacing a PVC profile.

6. The method of claim 1, wherein a biodegradability of the PLA is reduced.

7. The method of claim 1, further comprising adding a filler to the PLA.

8. The method of claim 1, further comprising adding an additive to the PLA.

9. The method of claim 1, further comprising extruding the PLA to form the profile, wherein the profile is a high tolerance three dimensional shape.

10. A method of viscoelastic processing of polylactic acid (PLA), comprising:
heating the PLA to a temperature below its melt processing point such that it is in a molten state, and
extruding the molten PLA to form a high tolerance crystalline profile extrusion component.

11. The method of claim 10, wherein the profile component comprises a baseboard.

12. The method of claim 10, wherein the profile component comprises a window profile.

13. The method of claim 10, wherein the profile component comprises an edgebanding.

14. The method of claim 10, wherein the profile component comprises architectural millwork.

15. The method of claim 10, wherein the profile component comprises an architectural corner guard.

16. The method of claim 10, wherein the profile component comprises a door component.

17. The method of claim 10, wherein the profile component comprises a pipe.

18. The method of claim 10, wherein the profile component comprises a replacement for rigid PVC profiles.
